(19) United States
(12) Patent Application Publication
(10) Pub. No.: US 2008/0142038 A1
(43) Pub. Date: Jun. 19, 2008

(54) SURFACE TREATMENT OF MEDICAL DEVICES

(75) Inventors: Jay F. Kunzler, Canandaigua, NY (US); Mark Stachowski, Fairport, NY (US); Jeffrey G. Linhardt, Fairport, NY (US); Joseph C. Salamone, Boca Raton, FL (US)

Correspondence Address: Bausch & Lomb Incorporated, One Bausch & Lomb Place, Rochester, NY, 14604-2701, US

(73) Assignee: Bausch & Lomb Incorporated, Rochester, NY (US)

(21) Appl. No.: 11/924,336

(22) Filed: Oct. 25, 2007

Related U.S. Application Data
(60) Provisional application No. 60/870,164, filed on Dec. 15, 2006.

(51) Int. Cl. B08B 7/00

(52) U.S. Cl. 134/1.1

(57) ABSTRACT

A method for improving the wettability of a medical device is provided, the method comprising the steps of (a) providing a medical device formed from a monomer mixture comprising a hydrophilic monomer and a siloxy-containing monomer, (b) subjecting a surface of the medical device to a surface treatment, and (c) contacting the treated surface of the medical device with a wetting agent solution comprising a carboxylic acid-containing polymer or copolymer to form a carboxylic acid-containing polymeric or copolymeric layer on the treated surface of the medical device.

### BACKGROUND OF THE INVENTION

1. Technical Field

The present invention is directed to the surface treatment of medical devices including ophthalmic lenses, stents, implants and catheters to increase their wettability.

2. Description of Related Art

Medical devices such as ophthalmic lenses made from, for example, silicone-containing materials, have been investigated for a number of years. Such materials can generally be subdivided into two major classes, namely hydrogels and non-hydrogels. Hydrogels can absorb and retain water in an equilibrium state, whereas non-hydrogels do not absorb appreciable amounts of water. Regardless of their water content, both hydrogel and non-hydrogel silicone medical devices tend to have relatively hydrophobic, non-wettable surfaces that may have a high affinity for lipids. This problem is of particular concern with contact lenses.

Those skilled in the art have long recognized the need for modifying the surface of such silicone contact lenses so that they are compatible with the eye. It is known that increased hydrophilicity of the contact lens surface improves the wettability of the lens. This, in turn, is associated with improved wear comfort of contact lenses. Additionally, the surface of the lens can affect the lens's susceptibility to deposition, particularly the deposition of proteins and lipids resulting from tear fluid during lens wear. Accumulated deposition can cause eye discomfort or even inflammation. In the case of extended wear lenses (i.e., lenses used without daily removal of the lens before sleep), the surface is especially important, since extended wear lenses must be designed for high standards of comfort and biocompatibility over an extended period of time.

Silicone lenses have been subjected to plasma surface treatment to improve their surface properties, e.g., surfaces have been rendered more hydrophilic, deposit resistant, scratch-resistant, or otherwise modified. Examples of previously disclosed plasma surface treatments include subjecting the surface of a contact lens to a plasma containing an inert gas or oxygen (see, for example, U.S. Pat. Nos. 4,055,378; 4,122,942; and 4,214,014); various hydrocarbon monomers (see, for example, U.S. Pat. No. 4,143,949); and combinations of oxidizing agents and hydrocarbons such as water and ethanol (see, for example, WO 95/04609 and U.S. Pat. No. 4,632,844). U.S. Pat. No. 4,312,575 discloses a process for providing a barrier coating on a silicone or polyurethane lens by subjecting the lens to an electrical glow discharge (plasma) process conducted by first subjecting the lens to a hydrocarbon atmosphere followed by subjecting the lens to oxygen during flow discharge, thereby increasing the hydrophilicity of the lens surface.

U.S. Pat. Nos. 4,168,112, 4,321,261 and 4,436,730 disclose methods for treating a charged contact lens surface with an oppositely charged ionic polymer to form a polyelectrolyte complex on the lens surface that improves wettability.

U.S. Pat. No. 4,287,175 discloses a method of wetting a contact lens that comprises inserting a water-soluble solid polymer into the cul-de-sac of the eye. The disclosed polymers include cellulose derivatives, acrylates and natural products such as gelatin, pectins and starch derivatives.

U.S. Pat. No. 5,397,848 discloses a method of incorporating hydrophilic constituents into silicone polymer materials for use in contact and intraocular lenses.

U.S. Pat. Nos. 5,700,559 and 5,807,636 disclose hydrophilic articles (e.g., contact lenses) comprising a substrate, an ionic polymeric layer on the substrate and a disordered polyelectrolyte coating ionically bonded to the polymeric layer.

U.S. Pat. No. 5,705,583 discloses biocompatible polymeric surface coatings. The polymeric surface coatings disclosed include coatings synthesized from monomers bearing a center of positive charge, including cationic and zwitterionic monomers.

European Patent Application No. EP 0 963 761 A1 discloses medical devices with coatings that are said to be stable, hydrophilic and antimicrobial, and which are formed using a coupling agent to bond a carboxyl-containing hydrophilic coating to the surface of the devices by ester or amide linkages.

U.S. Pat. No. 6,428,839 discloses a method for improving the wettability of a medical device which includes the steps of (a) providing a medical device formed from a monomer mixture comprising a hydrophilic monomer and a silicone-containing monomer, wherein said medical device has not been subjected to a surface oxidation treatment; and (b) contacting a surface of the medical device with a solution comprising a proton-donating wetting agent, whereby the wetting agent forms a complex with the hydrophilic monomer on the surface of the medical device in the absence of a surface oxidation treatment step and without the addition of a coupling agent.

It would be desirable to provide improved methods for making a medical device such as a silicone hydrogel contact lens with an optically clear, hydrophilic surface film that will not only exhibit improved wettability, but which will generally allow the use of a silicone hydrogel contact lens in the human eye for an extended period of time. In the case of a silicone hydrogel lens for extended wear, it would be desirable to provide a contact lens with a surface that is also highly permeable to oxygen and water. Such a surface treated lens would be comfortable to wear in actual use and would allow for the extended wear of the lens without irritation or other adverse effects to the cornea.

### SUMMARY OF THE INVENTION

In accordance with one embodiment of the present invention, a method for improving the wettability of a medical device is provided comprising the steps of (a) providing a medical device formed from a monomer mixture comprising a hydrophilic monomer and a siloxy-containing monomer, (b) subjecting a surface of the medical device to a surface treatment, and (c) contacting the treated surface of the medical device with a wetting agent solution comprising a carboxylic acid-containing polymer or copolymer to form a carboxylic acid-containing polymeric or copolymeric layer on the treated surface of the medical device.

In accordance with a second embodiment of the present invention, a method for improving the wettability of a medical device is provided comprising the steps of (a) providing a medical device formed from a monomer mixture comprising a hydrophilic monomer and a siloxy-containing monomer, (b) subjecting a surface of the medical device to a surface treatment, and (c) contacting the treated surface of the medical device with a wetting agent solution comprising a carboxylic acid-containing polymer or copolymer to form a carboxylic acid-containing polymeric or copolymeric layer on the treated surface of the medical device.

In accordance with a third embodiment of the present invention, a method for improving the wettability of a medical device is provided comprising the steps of (a) providing a medical device formed from a monomer mixture comprising a siloxy-containing monomer and at least one hydrophilic monomer selected from the group consisting of N-vinyl-2-pyrrolidone and N,N-dimethylacrylamide, (b) subjecting a surface of the medical device to a surface oxidation treatment, and (c) contacting the oxidized surface of the medical device with a wetting agent solution comprising a polymer or copolymer of acrylic acid to form an acrylic acid polymeric or copolymeric layer on the surface of the medical device.

### DETAILED DESCRIPTION OF THE PREFERRED EMBODIMENTS

The present invention provides a medical device such as a silicone hydrogel contact lens having a coating and a method of manufacturing the same. The coating of the medical device is believed to improve the hydrophilicity and lipid resistance of the medical device. The poly(acrylic acid) complexation coating can allow a lens that could otherwise not be comfortably worn in the eye to be worn in the eye for an extended period of time, for example, more than 24 hours at a time. The preferred medical devices are ophthalmic devices, more preferably contact lenses, and most preferably contact lenses made from silicone hydrogels. The medical devices such as wettable silicone-based hydrogel formulations can be prepared by a surface treatment followed by a carboxylic acid-containing polymer or copolymer, e.g., poly(acrylic acid) (PAA), surface complexation to render a lubricious, stable, highly wettable carboxylic acid-containing polymeric or copolymeric based surface coating on the medical device.

As used herein, the terms “lens” and “opthalmic device” refer to devices that reside in or on the eye. These devices can provide optical correction, wound care, drug delivery, diagnostic functionality or cosmetic enhancement or effect or a combination of these properties. Representative examples of such devices include, but are not limited to, soft contact lenses, e.g., soft, hydrogel lens, soft, non-hydrogel lens and the like, hard contact lenses, e.g., hard, gas permeable lens materials and the like, intraocular lenses, overlay lenses, ocular inserts, optical inserts and the like. As is understood by one skilled in the art, a lens is considered to be “soft” if it can be folded back upon itself without breaking. Any material known to produce a medical device including an ophthalmic device can be used herein.

It is particularly useful to employ biocompatible materials herein including both soft and rigid materials commonly used for opthalmic lenses, including contact lenses. The preferred substrates are hydrogel materials, including silicone hydrogel materials. Particularly preferred materials include vinyl functionalized polydimethylsiloxanes copolymerized with hydrophilic monomers as well as fluorinated methacrylates and methacrylate functionalized fluorinated polyethylene oxides copolymerized with hydrophilic monomers. Representative examples of substrate materials for use herein include those disclosed in U.S. Pat. Nos. 5,310,779; 5,387,662; 5,449,729; 5,512,205; 5,610,252; 5,616,757; 5,708,094; 5,710,302; 5,714,557 and 5,908,906, the contents of which are incorporated by reference herein.

A wide variety of materials can be used herein, and silicone hydrogel contact lens materials are particularly preferred. Hydrogels in general are a well-known class of materials that comprise hydrated, crosslinked polymeric systems containing water in an equilibrium state. Silicone hydrogels generally have a water content greater than about 5 weight percent and more commonly between about 10 to about 80 weight percent. Such materials are usually prepared by polymerizing a mixture containing at least one siloxy-containing monomer and at least one hydrophilic monomer. Either a siloxy-containing monomer or a hydrophilic monomer functions as a crosslinking agent (a crosslinker being defined as a monomer having multiple polymerizable functionalities) or a separate crosslinker may be employed. Applicable siloxy-containing monomeric units for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Representative examples of applicable silicon-containing monomeric units include bulky polysiloxanylalkyl(meth)acrylic monomers. An example of a bulky polysiloxanylalkyl(meth)acrylic monomer is represented by the structure of Formula I:

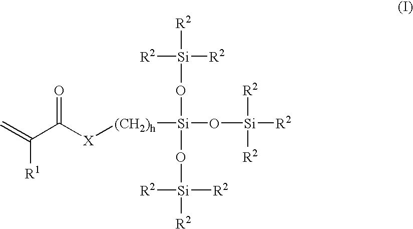

wherein X denotes —O— or —NR—; each R¹ independently denotes hydrogen or methyl; each R² independently denotes a lower alkyl radical, phenyl radical, alkylaryl radical, fluorocarbon radical or a group represented by

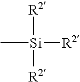

wherein each R²′ independently denotes a lower alkyl or phenyl radical; and h is 1 to 10.

Examples of bulky monomers are 3-methacryloxypropyltris(trimethylsiloxy)silane or tris(trimethylsiloxy)silylpropyl methacrylate, sometimes referred to as TRIS and tris(trimethylsiloxy)silylpropyl vinyl carbamate, sometimes referred to as TRIS-VC, and the like.

Such bulky monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

Another class of representative silicone-containing monomers includes, but is not limited to, silicone-containing vinyl carbonate or vinyl carbamate monomers such as, for example, 1,3-bis[4-vinyloxycarbonyloxy)but-1-yl]tetramethyldisiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae II and III:

E(*D*A*D*G)ₐ*D*A*D*E′; or (II)

E(*D*G*D*A)ₐ*D*A*D*E′; or (III)

wherein:

D independently denotes an alkyl diradical, an alkyl cycloalkyl diradical, a cycloalkyl diradical, an aryl diradical or an alkylaryl diradical having 6 to about 30 carbon atoms;

G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;

denotes a urethane or ureido linkage;

a is at least 1;

A independently denotes a divalent polymeric radical of Formula IV:

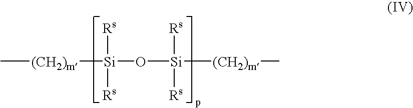

wherein each R^{S} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula V:

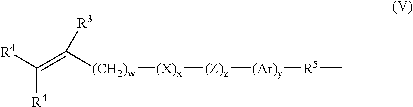

wherein: R³ is hydrogen or methyl;
R⁴ is hydrogen, an alkyl radical having 1 to 6 carbon atoms, or a —CO—Y—R⁶ radical wherein Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

A preferred silicone-containing urethane monomer is represented by Formula VI:

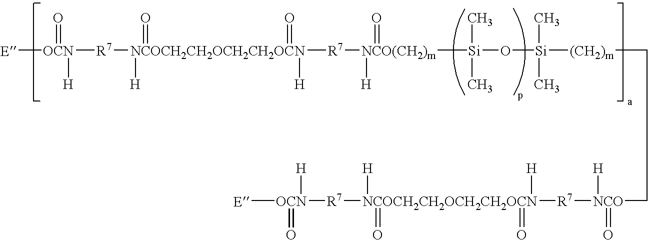

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

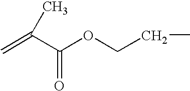

In another embodiment of the present invention, a silicone hydrogel material comprises (in bulk, that is, in the monomer mixture that is copolymerized) about 5 to about 50 percent, and preferably about 10 to about 25, by weight of one or more silicone macromonomers, about 5 to about 75 percent, and preferably about 30 to about 60 percent, by weight of one or more polysiloxanylalkyl (meth)acrylic monomers, and about 10 to about 50 percent, and preferably about 20 to about 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 discloses additional unsaturated groups, including acryloxy or methacryloxy. Fumarate-containing materials such as those disclosed in U.S. Pat. Nos. 5,310,779; 5,449,729 and 5,512,205 are also useful substrates in accordance with the invention. Preferably, the silane macromonomer is a silicon-containing vinyl carbonate or vinyl carbamate or a polyurethane-polysiloxane having one or more hard-soft-hard blocks and end-capped with a hydrophilic monomer.

Suitable hydrophilic monomers include amides such as N,N-dimethylacrylamide and N,N-dimethylmethacrylamide, cyclic lactams such as N-vinyl-2-pyrrolidone and poly(alkene glycol)s functionalized with polymerizable groups. Examples of useful functionalized poly(alkene glycol)s include poly(ethylene glycol)s of varying chain length containing monomethacrylate or dimethacrylate end caps. In a preferred embodiment, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art.

Another class of representative silicone-containing monomers includes fluorinated monomers. Such monomers have been used in the formation of fluorosilicone hydrogels to reduce the accumulation of deposits on contact lenses made therefrom, as disclosed in, for example, U.S. Pat. Nos. 4,954,587; 5,010,141 and 5,079,319. The use of silicone-containing monomers having certain fluorinated side groups, i.e., —(CF₂)ₓ—H, where x=1−10, have been found to improve compatibility between the hydrophilic and silicone-containing monomeric units. See, e.g., U.S. Pat. Nos. 5,321,108 and 5,387,662.

The above silicone materials are merely exemplary, and other materials for use as substrates that can benefit by being coated with the hydrophilic gradient coating according to the present invention and have been disclosed in various publications and are being continuously developed for use in contact lenses and other medical devices can also be used.

Contact lenses for application of the present invention can be manufactured employing various conventional techniques, to yield a shaped article having the desired posterior and anterior lens surfaces. Spincasting methods are disclosed in U.S. Pat. Nos. 3,408,429 and 3,660,545; and static casting methods are disclosed in U.S. Pat. Nos. 4,113,224, 4,197,266 and 5,271,876. Curing of the monomeric mixture may be followed by a machining operation in order to provide a contact lens having a desired final configuration. As an example, U.S. Pat. No. 4,555,732 discloses a process in which an excess of a monomeric mixture is cured by spincasting in a mold to form a shaped article having an anterior lens surface and a relatively large thickness. The posterior surface of the cured spincast article is subsequently lathe cut to provide a contact lens having the desired thickness and posterior lens surface. Further machining operations may follow the lathe cutting of the lens surface, for example, edge-finishing operations.

Typically, an organic diluent is included in the initial monomeric mixture in order to minimize phase separation of polymerized products produced by polymerization of the monomeric mixture and to lower the glass transition temperature of the reacting polymeric mixture, which allows for a more efficient curing process and ultimately results in a more uniformly polymerized product. Sufficient uniformity of the initial monomeric mixture and the polymerized product is of particular importance for silicone hydrogels, primarily due to the inclusion of silicone-containing monomers which may tend to separate from the hydrophilic comonomer. Suitable organic diluents include, for example, monohydric alcohols such as C₆-C₁₀ straight-chained aliphatic monohydric alcohols, e.g., n-hexanol and n-nonanol; diols such as ethylene glycol; polyols such as glycerin; ethers such as diethylene glycol monoethyl ether; ketones such as methyl ethyl ketone; esters such as methyl enanthate; and hydrocarbons such as toluene. Preferably, the organic diluent is sufficiently volatile to facilitate its removal from a cured article by evaporation at or near ambient pressure. Generally, the diluent may be included at about 5 to about 60 percent by weight of the monomeric mixture, with about 10 to about 50 percent by weight being preferred. If necessary, the cured lens may be subjected to solvent removal, which can be accomplished by evaporation at or near ambient pressure or under vacuum. An elevated temperature can be employed to shorten the time necessary to evaporate the diluent.

Following removal of the organic diluent, the lens can then be subjected to mold release and optional machining operations. The machining step includes, for example, buffing or polishing a lens edge and/or surface. Generally, such machining processes may be performed before or after the article is released from a mold part. As an example, the lens may be dry released from the mold.

Next, the lens is subjected to a surface treatment according to the present invention. The foregoing medical devices such as wettable silicone-based hydrogel lenses are then subjected to an oxidative surface treatment such as corona discharge or plasma oxidation followed by a carboxylic acid-containing polymer or copolymer surface complexation. Medical devices such as silicone hydrogel formulations containing hydrophilic polymers, such as poly(N,N-dimethylacrylamide) or poly(N-vinylpyrrolidinone), are subjected to a surface treatment and then treated with water-based solutions containing carboxylic acid-containing polymer or copolymer to render a lubricious, stable, highly wettable carboxylic acid-containing polymeric or copolymeric based surface coating. The complexation treatment is advantageously performed under autoclave conditions.

The standard process such as a plasma process (also referred to as “electrical glow discharge processes”) provides a thin, durable surface upon the medical device preliminary to the covalently bonded attachment of preformed hydrophilic polymers or copolymers. Examples of such plasma processes are provided in U.S. Pat. Nos. 4,143,949; 4,312,575; and 5,464,667.

Although plasma processes are generally well known in the art, a brief overview is provided below. Plasma surface treatments involve passing an electrical discharge through a gas at low pressure. The electrical discharge may be at radio frequency (typically 13.56 MHz), although microwave and other frequencies can be used. Electrical discharges produce ultraviolet (UV) radiation, in addition to being absorbed by atoms and molecules in their gas state, resulting in energetic electrons and ions, atoms (ground and excited states), molecules, and radicals. Thus, a plasma is a complex mixture of atoms and molecules in both ground and excited states, which reach a steady state after the discharge is begun. The circulating electrical field causes these excited atoms and molecules to collide with one another as well as the walls of the chamber and the surface of the material being treated.

The deposition of a coating from a plasma onto the surface of a material has been shown to be possible from high-energy plasmas without the assistance of sputtering (sputter-assisted deposition). Monomers can be deposited from the gas phase and polymerized in a low pressure atmosphere (about 0.005 to about 5 torr, and preferably about 0.001 to about 1 torr) onto a substrate utilizing continuous or pulsed plasmas, suitably as high as about 1000 watts. A modulated plasma, for example, may be applied about 100 milliseconds on then off. In addition, liquid nitrogen cooling has been utilized to condense vapors out of the gas phase onto a substrate and subsequently use the plasma to chemically react these materials with the substrate. However, plasmas do not require the use of external cooling or heating to cause the deposition. Low or high wattage (e.g., about 5 to about 1000, and preferably about 20 to about 500 watts) plasmas can coat even the most chemical-resistant substrates, including silicones.

After initiation by a low energy discharge, collisions between energetic free electrons present in the plasma cause the formation of ions, excited molecules, and free-radicals. Such species, once formed, can react with themselves in the gas phase as well as with further ground-state molecules. The plasma treatment may be understood as an energy dependent process involving energetic gas molecules. For chemical reactions to take place at the surface of the lens, one needs the required species (element or molecule) in terms of charge state and particle energy. Radio frequency plasmas generally produce a distribution of energetic species. Typically, the “particle energy” refers to the average of the so-called Boltzman-style distribution of energy for the energetic species. In a low-density plasma, the electron energy distribution can be related by the ratio of the electric field strength sustaining the plasma to the discharge pressure (E/p). The plasma power density P is a function of the wattage, pressure, flow rates of gases, etc., as will be appreciated by the skilled artisan. Background information on plasma technology, hereby incorporated by reference, includes the following: A. T. Bell, Proc. Intl. Conf. Phenom. Ioniz. Gases, “Chemical Reaction in Nonequilibrium Plasmas”, 19-33 (1977); J. M. Tibbitt, R. Jensen, A. T. Bell, M. Shen, Macromolecules, “A Model for the Kinetics of Plasma Polymerization”, 3, 648-653 (1977); J. M. Tibbitt, M. Shen, A. T. Bell, J. Macromol. Sci.-Chem., “Structural Characterization of Plasma-Polymerized Hydrocarbons”, A10, 1623-1648 (1976); C. P. Ho, H. Yasuda, J. Biomed, Mater. Res., “Ultrathin coating of plasma polymer of methane applied on the surface of silicone contact lenses”, 22, 919-937 (1988); H. Kobayashi, A. T. Bell, M. Shen, Macromolecules, “Plasma Polymerization of saturated and Unsaturated Hydrocarbons”, 3, 277-283 (1974); R. Y. Chen, U.S. Pat. No., 4,143,949, Mar. 13, 1979, “Process for Putting a Hydrophilic Coating on a Hydrophobic Contact lens”; and H. Yasuda, H. C. Marsh, M. O. Bumgarner, N. Morosoff, J. of Appl. Poly. Sci., “Polymerization of Organic Compounds in an Electroless Glow Discharge. VI. Acetylene with Unusual Co-monomers”, 19, 2845-2858 (1975).

Based on this previous work in the field of plasma technology, the effects of changing pressure and discharge power on the rate of plasma modification can be understood. The rate generally decreases as the pressure is increased. Thus, as pressure increases the value of E/p, the ratio of the electric field strength sustaining the plasma to the gas pressure decreases and causes a decrease in the average electron energy. The decrease in electron energy in turn causes a reduction in the rate coefficient of all electron-molecule collision processes. A further consequence of an increase in pressure is a decrease in electron density. Providing that the pressure is held constant, there should be a linear relationship between electron density and power.

In practice, contact lenses are surface-treated by placing them, in their unhydrated state, within an electric glow discharge reaction vessel (e.g., a vacuum chamber). Such reaction vessels are commercially available. The lenses may be supported within the vessel on an aluminum tray (which acts as an electrode) or with other support devices designed to adjust the position of the lenses. The use of a specialized support devices which permit the surface treatment of both sides of a lens are known in the art and may be used herein

As mentioned above, the surface of the lens, for example, a silicone hydrogel continuous-wear lens is initially treated, e.g., oxidized, by the use of a plasma to render the subsequent carboxylic acid-containing polymeric or copolymeric surface deposition more adherent to the lens. Such a plasma treatment of the lens may be accomplished in an atmosphere composed of a suitable media, e.g., an oxidizing media such as oxygen or nitrogen-containing compounds: ammonia, an aminoalkane, air, water, peroxide, O₂ (oxygen gas), methanol, acetone, alkylamines, etc., or appropriate combinations thereof, typically at an electric discharge frequency of about 13.56 Mhz, preferably between about 20 to about 500 watts at a pressure of about 0.1 to about 1.0 torr, preferably for about 10 seconds to about 10 minutes or more, more preferably about 1 to about 10 minutes. It is preferred that a relatively “strong” plasma is utilized in this step, for example, ambient air drawn through a five percent (5%) hydrogen peroxide solution. Those skilled in the art will know other methods of improving or promoting adhesion for bonding of the subsequent carboxylic acid-containing polymeric or copolymeric layer. For example, a plasma with an inert gas will also improve bonding. It would also be possible to deposit a silicon-containing monomer to promote adhesion or other organic-containing monomer plasmas.

Surface coating materials useful in the present invention include any suitable carboxylic acid-containing polymer or copolymer. Suitable carboxylic acid-containing polymer or copolymers include, but are not limited to, poly(vinylpyrrolidinone(VP)-co-acrylic acid(AA)), poly(methylvinylether-alt-maleic acid), poly(acrylic acid-graft-ethylene oxide), poly(acrylic acid-co-methacrylic acid), poly(acrylamide-co-AA), poly(AA-co-maleic acid), and poly(butadiene-maleic acid). In one embodiment, carboxylic acid-containing polymers or copolymers are characterized by carboxylic acid contents of at least about 30 mole percent and preferably at least about 40 mole percent.

Solvents useful in the surface treatment (contacting) step of the present invention include solvents that readily solubilize proton donating solutes such as carboxylic acids, sulfonic acids, fumaric acid, maleic acid, anhydrides such as maleic anhydride and functionalized alcohols such as vinyl alcohol. Preferred solvents include tetrahydrofuran (THF), acetonitrile, N,N-dimethyl formamide (DMF), and water. The most preferred solvent is water.

The surface treatment solution is preferably acidified before the contact step. The pH of the solution is suitably less than about 7, preferably less than about 5 and more preferably less than about 4. In a particularly preferred embodiment, the pH of the solution is about 3.5. For a discussion of the theory underlying the role of pH in complexation reactions in general, see Advances in Polymer Science, published by Springer-Verlag, Editor H. J. Cantow, et al, V45, 1982, pages 17-63.

The present invention is further illustrated by the following examples which are provided merely to be exemplary of the invention and do not limit the scope of the invention. Certain modifications and equivalents will be apparent to those skilled in the art and are intended to be included within the scope of the present invention.

### EXAMPLE

Treatment of Contact Lenses With Plasma Followed by Poly(AcrylicAcid)

A monomer formulation prepared from polymerizable dialkyl siloxanes and a polymerizable fluoroalkyl siloxane was cast into contact lenses in a polypropylene mold by curing under ultraviolet (“UV”) light. The lenses were released from the molds using liquid nitrogen. The lenses were treated with different plasmas as grouped lots in a March FlexTrak plasma chamber at a loading of 50 lenses per lot in a chamber load, as shown below in Table 1. After completion of the plasma treatment, the lenses were extracted in a bath of isopropanol (“IPA”) for 4 hours, re-hydrated in water, and packaged into polypropylene blister packs in a coating solution as also shown below in Table 1.

TABLE 1

| | Plasma | | Package |
|---|---|---|---|
| Lot # | Treatment | Polymer Coating | Solution |
| 1 | NHx | none (Plasma | BBS¹ |
| | | Control) | |
| 2 | O₂ | none (Plasma | BBS |
| | | Control) | |
| 3 | O₂ | 1% PAA | MOPS² |
| 4 | Ammonia | 1% PAA | MOPS |

¹Borate-buffered saline (BBS)
²3-(N-morpholino)propanesulfonic acid (MOPS)
³Poly (acrylic acid) (PAA)

The packaged lenses were sterilized in steam in an autoclave, for example, at a temperature up to and including 100° C. The sterilization temperature can be higher if super heated steam is used. However, the sterilization temperature should not be high enough to negatively affect the polymeric article and the package. Alternatively, sterilization can be effect by radiation, such as gamma or e-beam radiation.

Samples of these packages were then randomly opened and inspected. Cloud-clarity qualitative ratings of the treated lenses, compared to the untreated controls were assigned. Further chemical characterization on the lenses was conducted using X-Ray photoelectron spectroscopy (“XPS”) to determine changes in the surface chemistry as a measure of coating efficiency. Three lenses from each lot were tested following desalination, after the lenses were cut into quarters and mounted for XPS analysis with one-quarter of a lens posterior side up and one-quarter of a lens anterior side up (3 samples each side). Survey spectra were obtained for one spot on each lens quarter for XPS. Atomic concentration data obtained from XPS analyses of the four coating combinations presented shows that both plasma treatment and coating solution are important in that the elemental concentrations varied, indicative of coating efficiency. The results are set forth below in Table 2.

TABLE 2

| | Fully Processed XPS Data | | | | | | Clarity/ |
|---|---|---|---|---|---|---|---|
| Lot # | C1s | N1s | O1s | F1s | Si2p | Na1s | Cloudy |
| 1 | 59.2 | 6.4 | 20.1 | 3.4 | 10.9 | N/A | 5/5 |
| | 0.69 | 0.20 | 0.45 | 0.33 | 0.24 | | |
| 2 | 60.0 | 5.9 | 20.4 | 2.8 | 10.8 | N/A | 5/4 |
| | 0.56 | 0.25 | 0.26 | 0.23 | 0.38 | | |
| 3 | 55.8 | 2.9 | 27.5 | 1.7 | 6.3 | 5.8 | 5/5 |
| | 2.51 | 2.39 | 5.99 | 1.70 | 4.98 | 5.56 | |
| 4 | 53.5 | 0.7 | 32.9 | 0.1 | 1.8 | 10.9 | 5/5 |
| | 0.80 | 0.57 | 1.26 | 0.21 | 1.11 | 1.30 | |

It can be seen form the data presented in Table 2, that both plasma treatments followed by a polyacrylic acid coating reduces the hydrophobic moieties as compared to lenses that are only plasma treated. The coating efficiency, as characterized by a decrease in the elements of silicon and fluorine representing the hydrophobic species (such as silicone and fluorohydrocarbons), is a combination of both the plasma and coating with each playing a role in reducing such hydrophobic moieties. The oxygen and ammonia plasma treated surfaces from plasma treatments alone appeared chemically similar, with ca. 3% fluorine (F1s) and ca. 11% silicon (Si2p) for lots 1 and 2 respectively. However, the resulting coated lenses have significantly different levels of the same hydrophobic species at levels of ca. 2% and 0% fluorine, and ca. 6% and ca. 2% silicon, for lots 3 and 4 respectively. It can also be seen that a significant increase in oxygen and sodium (due to bound saline) are found both in lots 3 and 4, likely due to enhanced hydrophilic moieties, though the gains are even greater in lot 4 with an ammonia plasma. Lenses from lots 3 and 4 received the highest rating of 5 for 5 for both clarity and cloudy (the clearest and least cloudy possible), with gains over an oxygen plasma only.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A method for improving the wettability of a medical device, the method comprising the steps of (a) providing a medical device formed from a monomer mixture comprising a hydrophilic monomer and a siloxy-containing monomer, (b) subjecting a surface of the medical device to a surface treatment to provide reactive functionalities on the surface of the medical device, and (c) contacting the treated surface of the medical device with a wetting agent solution comprising a carboxylic acid-containing polymer or copolymer to form a carboxylic acid-containing polymeric or copolymeric layer on the treated surface of the medical device.

2. The method of claim 1, wherein the medical device comprises in bulk formula about 5 to about 50 percent by weight of one or more silicone macromonomers and about 5 to about 50 percent by weight of a hydrophilic monomer.

3. The method of claim 2, wherein the hydrophilic monomer is selected from the group consisting of unsaturated carboxylic acids, vinyl lactams, acrylamides, polymerizable amines, vinyl carbonate or vinyl carbamate, oxazolone monomers, and mixtures thereof.

4. The method of claim 2, wherein the hydrophilic monomer is selected from the group consisting of methacrylic and acrylic acids, 2-hydroxyethylmethacrylate, N-vinylpyrrolidone, methacrylamide, N,N-dimethylacrylamide, and mixtures thereof.

5. The method of claim 1, wherein the surface treatment comprises oxidation of the surface with a nitrogen or oxygen-containing oxidizing gas.

6. The method of claim 5, wherein the oxygen-containing or nitrogen-containing gas selected comprises one or more of ambient air, oxygen gas, ammonia, hydrogen peroxide, alcohol, and water.

7. The method of claim 1, wherein the carboxylic acid-containing polymer or copolymer in the wetting agent solution is characterized by an acid content of at least about 40 mole percent.

8. The method of claim 1, wherein the polymer or copolymer of acrylic acid is selected from the group consisting of poly(N-vinylpyrolidinone(NVP)-co-acrylic acid(AA)), poly(methylvinyl ether-alt-maleic acid), poly(acrylic acid-graft-ethylene oxide), poly(acrylic acid-co-methacrylic acid), poly(acrylamide-co-AA), poly(acrylamide-co-methacrylic acid), and poly(butadiene-co-maleic acid).

9. The method of claim 1, further comprising acidifying the solution of step (c) to provide a solution pH of less than about 5.

10. The method of claim 1, wherein the medical device is an opthalmic lens.

11. The method of claim 10, wherein the opthalmic lens is a contact lens.

12. The method of claim 11, wherein the contact lens is a silicone hydrogel lens.

13. A method for improving the wettability of a medical device, the method comprising the steps of (a) providing a medical device formed from a monomer mixture comprising a hydrophilic monomer and a siloxy-containing monomer, (b) subjecting a surface of the medical device to a surface treatment, and (c) contacting the treated surface of the medical device with a wetting agent solution comprising a carboxylic acid-containing polymer or copolymer to form a carboxylic acid-containing polymeric or copolymeric layer on the treated surface of the medical device.

14. The method of claim 13, wherein the medical device comprises in bulk formula about 5 to about 50 percent by weight of one or more silicone macromonomers and about 5 to about 50 percent by weight of a hydrophilic monomer.

15. The method of claim 13, wherein the carboxylic acid-containing polymer or copolymer is characterized by an acid content of at least about 40 mole percent.

16. The method of claim 15, wherein the carboxylic acid-containing polymer or copolymer is characterized by acid content of at least about 50 mole percent.

17. A method for improving the wettability of a medical device, the method comprising the steps of (a) providing a medical device formed from a monomer mixture comprising a siloxy-containing monomer and at least one hydrophilic monomer selected from the group consisting of N-vinyl-2-pyrrolidone and N,N-dimethylacrylamide, (b) subjecting a surface of the medical device to a surface treatment, and (c) contacting the treated surface of the medical device with a wetting agent solution comprising a carboxylic acid-containing polymer or copolymer to form a carboxylic acid-containing polymeric or copolymeric layer on the treated surface of the medical device.

18. The method of claim 17, wherein the surface treatment comprises oxidation of the surface with a nitrogen or oxygen-containing oxidizing gas.

19. The method of claim 17, wherein the wetting agent solution comprises at least one polymer selected from the group consisting of poly(acrylic acid) and poly(acrylic acid-co-acrylamide).

20. The method of claim 17, further comprising acidifying the solution of step (c) to provide a solution pH of less than about 5.
